(19) United States
(12) Patent Application Publication
(10) Pub. No.: US 2009/0098516 A1
(43) Pub. Date: Apr. 16, 2009

(54) Interactive grammar teaching methods and system therefor

(76) Inventor: Frank Chiarelli, Ottawa (CA)

Correspondence Address: JEFFREY S. SOKOL;COOK & FRANKE S.C., 660 East Mason Street, Milwaukee, WI, 53202, US

(21) Appl. No.: 11/974,646

(22) Filed: Oct. 15, 2007

(51) Int. Cl. G09B 19/00

(52) U.S. Cl. 434/167

(57) ABSTRACT

Interactive grammar teaching methods and apparatus are presented. Grammar lessons, grammar sentences, grammar exercises, and grammar tests are stored in respective repositories. Based on queries, grammar lessons are produced, and grammar exercises and tests are generated. A feedback generator receives completed grammar exercises and tests, tabulates expected answer and received answer pairs for each question. Grammar lessons may be recalled during an exercise. Test results may further be sorted by grammar lesson. Grammar lessons or lesson specific grammar exercises or tests are produced in respect of questions answered incorrectly or in respect of lessons in respect of which the level of proficiency demonstrated in a received completed grammar test is found below a desired level of proficiency. A combination of all grammar lessons and a list of grammar lessons produced, and a list of received completed grammar exercises and tests are compiled into a grammar manual and workbook.

### FIELD OF THE INVENTION

The invention relates to methods and apparatus for teaching grammar and in particular to interactive computing-assisted methods and apparatus for teaching grammar.

### BACKGROUND OF THE INVENTION

In the field of language arts education, the teaching of grammar has been absent in the last few decades. A significant proportion of North American school boards decided sometime ago to completely forgo the teachings of the rigors of English grammar as such rigorous training was found, by some studies at the time, to limit the creativity of students. That thinking was regarded as sound then and a large proportion of school boards followed suit.

That decision led to current day realities which include: modern poetry, highly trained adults relying heavily on conversational context to interact verbally and in writing, and standardized testing which does not show correlation between candidate's knowledge retention and knowledge application due to lack of clarity in taught expression.

Recently standardized testing bodies have made a decision to impose grammatical correctness in assessing candidate competency. This decision led to some school boards reinstating grammar teaching. Unfortunately, studies have found that the level of grammar knowledge of teaching staff, including highly trained individuals, varied substantially, while sufficient English grammar knowledge was found lacking overall.

Currently, while a significant yet comparatively small, number of teaching staff has sufficient grammar knowledge to teach, school boards are unable to meet even self-imposed desirable expectations in raising student grammar knowledge to acceptable levels. Recent known efforts have only concentrated on making grammar teaching palatable and fun.

There is a pressing need to mitigate the general grammar knowledge deficit at large.

### SUMMARY OF THE INVENTION

In accordance with a broad aspect of the present invention, there is provided an interactive system for teaching grammar, the system comprising: a grammar lesson repository configured to retrievably store a plurality of grammar lessons, each grammar lesson having a list of prerequisite lessons associated therewith, the plurality of prerequisite list entries defining a lesson hierarchy; a sentence repository configured to retrievably store a plurality of sentences, each sentence having a list of grammar lesson associations, each lesson association specifying a question and an expected answer; one of: an exercise generator configured to produce a grammar exercise according to grammar exercise parameters, and a test generator configured to produce a grammar test according to grammar test parameters; and a feedback generator configured to receive at least one of a completed grammar test and a completed grammar exercise, and provide feedback thereon.

In accordance with another broad aspect of the present invention, there is provided a method of administering a grammar test, the method comprising: receiving a completed grammar test including at least one tuple specifying an association between an answer received and a corresponding question; for each question in the completed test, the question including a tuple specifying an association between a sentence and a corresponding grammar lesson, querying a sentence repository based on the sentence and the question, the sentence repository being configured to retrievably store a plurality of sentences, each sentence having a list of grammar lesson associations, each lesson association specifying a question and an expected answer; obtaining the expected answer to the question; determining an indication of correctness of the provided answer; and tabulating the question, the sentence, the provided answer, the expected answer, and the indication of correctness.

In accordance with a further broad aspect of the present invention, there is provided method of administering a grammar exercise comprising the steps of: producing a grammar exercise without grammar lesson content, each question in the grammar exercise having a reference to a corresponding lesson; receiving an incomplete grammar exercise with a request to recall a grammar lesson; storing the incomplete grammar exercise; producing the requested grammar lesson; receiving a request to proceed with the grammar exercise; producing the incomplete grammar exercise without grammar lesson content; receiving a completed grammar exercise; and providing feedback on the completed grammar exercise.

In accordance with a further broad aspect of the present invention, there is provided one of: a server computer, a host computer, and a console comprising: a grammar lesson repository configured to retrievably store a plurality of grammar lessons, each grammar lesson having a list of prerequisite lessons associated therewith, the plurality of prerequisite list entries defining a lesson hierarchy; a sentence repository configured to retrievably store a plurality of sentences, each sentence having a list of grammar lesson associations, each lesson association specifying a question and an expected answer; a test generator configured to compile a group of questions into a grammar test according to grammar test parameters; an exercise generator configured to compile a group of questions into a grammar exercise according to grammar exercise parameters; and a feedback generator configured to receive a completed grammar test and provide feedback thereon.

In accordance with yet another broad aspect of the present invention, there is provided a computer-readable medium having computer-executable instructions for performing a method comprising: receiving a completed grammar test or a grammar exercise including at least one tuple specifying an association between an answer received and a corresponding question; for each question, the question including a tuple specifying an association between a sentence and a corresponding grammar lesson, querying a sentence repository based on the sentence and the question, the sentence repository being configured to retrievably store a plurality of sentences, each sentence having a list of grammar lesson associations, each lesson association specifying a question and an expected answer; obtaining the expected answer to the question; deriving an indication of correctness of the provided answer; and tabulating the question, the sentence, the provided answer, the expected answer, and the indication of correctness. The method further includes recalling a grammar lesson during for a student interacting with an exercise.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a schematic diagram showing elements of a grammar teaching system in accordance with an implementation of an embodiment of the invention;

FIG. 2 is a flow diagram showing process steps implementing a method of teaching grammar in accordance with the embodiment of the invention;

FIG. 3 is a schematic diagram showing elements of a grammar teaching system in accordance with another implementation of the embodiment of the invention; and

FIG. 4 is a flow diagram showing process steps implementing another method of teaching grammar in accordance with the embodiment of the invention.

### DETAILED DESCRIPTION OF THE EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

Given the prior art it was found that improved grammar retention was achieved via reinforcement of grammar concepts.

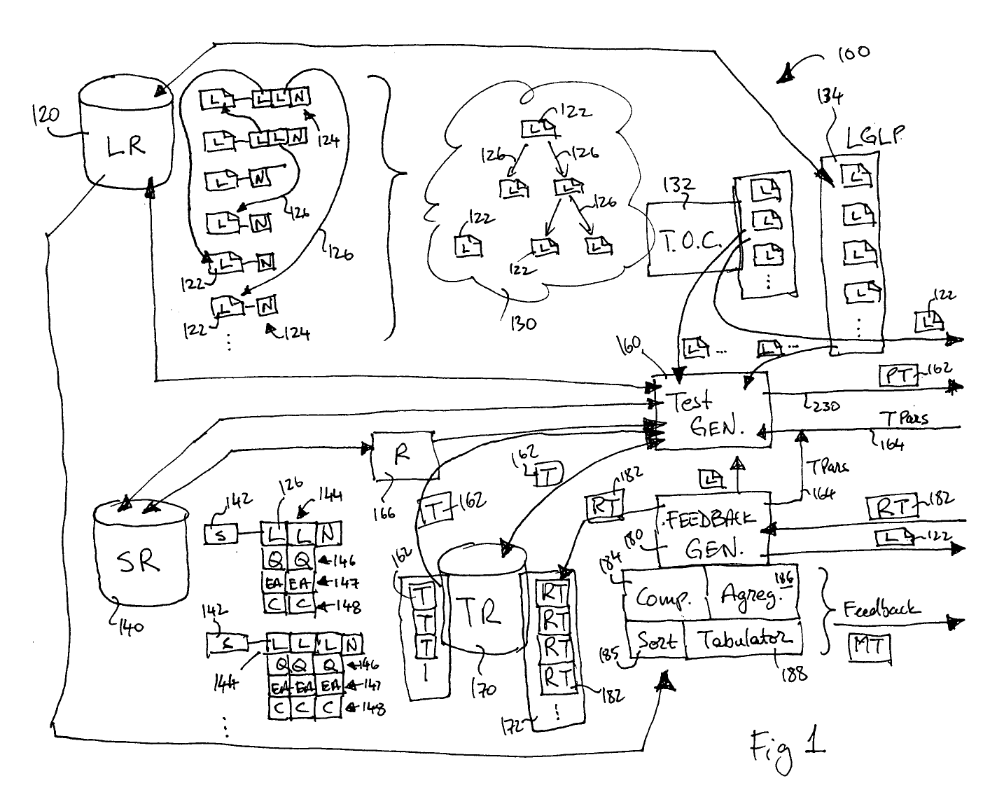

For example, FIG. 1 shows a grammar teaching system 100 in accordance with an implementation of an embodiment of the invention.

The grammar teaching system 100 includes a grammar lesson repository 120, a sentence repository 140, a grammar test generator 160, and a feedback generator 180.

The Grammar Lesson Repository

In accordance with the implementation of the embodiment of the invention presented herein, the grammar lesson repository 120 is configured to retrievably store a multitude of grammar lessons 122. A grammar lesson 122 includes, for example, an exposition of a grammar topic, and may include an example of a sentence analyzed along the lines of the subject matter presented in the grammar lesson 122.

Each grammar lesson 122 may have a list 124 of prerequisite lessons associated therewith. Each list of prerequisite lessons 124 may have a variable length. A stand-alone grammar lesson 122 has an empty list of prerequisite lessons 124 associated therewith.

For example, in accordance with an implementation of the embodiment of the invention, each list of prerequisite lessons 124 may include a linked list of grammar lesson identifiers 126. A prerequisite grammar lesson 122 is referenced in at least one a list of prerequisite lessons 124. In accordance with the example implementation presented herein, “a referenced grammar lesson” includes “a grammar lesson 122 pointed to from at least one list of prerequisite lessons 124, a table of contents 132, a list of grammar lessons 134, a list of grammar lesson associations 144, etc.” An empty list of perquisite lessons 124 may be implemented via a single entry having the pointer pointing to “NILL” signifying the end of the list of prerequisite lessons 124.

The combination of the multitude of grammar lessons 122 and the multitude of prerequisite specifications therefor define a grammar lesson hierarchy 130. Depending on implementation, the grammar lesson hierarchy 130 may be logical, that is, the logical representation of the information stored in all lists of prerequisite lessons 124, alternatively, the grammar lesson hierarchy 130 may include a data structure configured to retrievably store grammar lesson interdependencies. A representation of the grammar lesson hierarchy 130 may be output on a display of an electronic device or output in printed form. Depending on implementation, the grammar lesson hierarchy 130 may or may not include stand-alone grammar lessons 122.

In accordance with the embodiment of the invention, a table of contents 132 is provided. The table of contents 132 suggests a sequence of presentation of the multitude of grammar lessons 122 in the grammar lesson repository 120. Without limiting the invention, the table of contents 132 may be stored in the grammar lesson repository 120. The table of contents 132 may include stand-alone grammar lessons 122.

Without limiting the invention, an implementation of the table of contents 132 may include a list of grammar lessons 122. Depending on implementation, each entry in the table of contents 132 is one of: a reference, a link, or a pointer to a grammar lesson 122 in the grammar lesson repository 120, or a query to the grammar lesson repository 120 to produce the grammar lesson 122. The table of contents 132 is displayed via a user interface such as a display screen and may be interacted therewith to cause the production of grammar lessons 122 for display. The table of contents 132 may also be output in printed form.

Without limiting the invention, the table of contents 132 may: be based on the grammar lesson hierarchy 130, represent a particular traversal of the grammar lesson hierarchy 130, or correspond to a preferred sequence of presentation of grammar lessons 122.

In accordance with the implementation of the exemplary embodiment of the invention presented herein, the grammar lesson repository 120 is configured to produce a grammar lesson 122 on request. The sequence in which the grammar lessons 122 are produced may be stored, for example, in a list of grammar lessons produced 134. As will be described herein below, and without limiting the invention, grammar lessons requests may be the result of the interaction with a table of contents 132.

The Sentence Repository

In accordance with the proposed method of teaching grammar and in accordance with the implementation of the embodiment of the invention presented herein, the sentence repository 140 is configured to retrievably store a multitude of sentences 142. Each sentence 142 may be grammatically correct or grammatically incorrect. For example, a colloquial expression, despite being generally used, may not be grammatically correct (e.g. “It is I.” vs. “It is me.”)

Each sentence 142 may have a list 144 of grammar lesson (122) associations relevant to the grammar topics which apply to the sentence 142. Each list of grammar lesson associations 144 may have a variable length. The lists of grammar lesson associations may be stored in the sentence repository 140.

In accordance with the implementation of the embodiment of the invention presented herein, each list of grammar lesson associations 144 may include a linked list of data structures configured to store a grammar lesson identifier 126, a question 146, an expected answer 147, and optionally an indication of grammatical correctness 148 in respect of the grammar lesson 122 associated with the question 146. Without limiting the invention, the grammar lesson identifier 126 may be one of: a table of contents entry, a reference to a grammar lesson, a pointer to a grammar lesson 122 in the grammar lesson repository 120, and a query to the grammar lesson repository 120 to produce the grammar lesson 122. Depending on implementation, a “NILL” grammar lesson identifier 126 may be used to signify the end of the list of grammar lesson associations 144. For certainty, no limitations are contemplated for the format and contents of either one of the question 146 and the expected answer 147. Generally, the question 146 is formulated to elicit a specific answer, typically a specific word or a specific word grouping.

In accordance with the implementation of the exemplary embodiment of the invention presented herein, the sentence repository 140 is configured to produce a sentence 142 on request. Without limiting the invention, a request query includes a grammar lesson identifier 126 and optionally an indication of grammatical correctness 148. It is envisioned that the sentence repository 140 may employ a randomizer 166 to produce a random sentence 142 in response to a request when more than one sentence 142 is associated with a specified (126) grammar lesson 122.

The Grammar Test Generator

In accordance with the implementation of the embodiment of the invention presented herein, the grammar test generator 160 is configured to produce 230 a grammar test 162 according to grammar test parameters 164. A grammar test 162 includes a list of questions 146, each question 146 having a corresponding sentence 142 to which the question 146 relates.

The grammar test generator 160 is configured to obtain, from the sentence repository 140, at least one question 146/sentence 142 pair for inclusion in a grammar test 162. The grammar test generator 160 is configured to formulate at least one query for the sentence repository 140 based on the test parameters 164. As described herein above, a query submitted to the sentence repository may return a multitude of test questions 146. Obtaining a question 146 typically includes obtaining a corresponding sentence 142. It is envisioned that sentences 142 may be obtained from the sentence repository 140 on demand, for example by querying the sentence repository 140 with a specific question 146 via the association between the question 146 and the sentence 142.

Without limiting the invention, the grammar test parameters 164 may include: a list of grammar lessons to be tested, a number of questions to be tested, and optionally a desired mix of grammatical correctness of sentences to be compiled in the grammar test 162.

Without limiting the invention, as will be described herein below, an aptitude determination test may be requested by specifying the table of contents 130 as the list of grammar lessons to be tested, a lesson specific retention test may be requested by specifying (a list of grammar lessons containing) a specific grammar lesson 122, a grammar concept specific test may be requested by providing a list of selected grammar lessons 122 associated with the grammar concept, and a grammar retention test may be requested by specifying the list of grammar lessons produced 134 as the list of grammar lessons to be tested.

For example, the desired mix of grammatical correctness grammar test parameter may specify, when present, that only grammatically correct sentences be included in the grammar test 162, that only grammatically incorrect sentences be included in the grammar test 162, or that the grammar test 162 include sentences having mixed grammatical correctness. Depending on implementation, if the desired mix of grammatical correctness parameter is not specified, by default the generated test 162 may include only grammatically correct sentences or a 50/50 mix thereof, subject to sufficient numbers of grammatically correct and grammatically incorrect sentences 142 being available in the sentence repository 140 for the specified list of lessons.

Similarly, when the list of lessons includes more than one lesson 122, without limiting the invention, an equal number of questions 146 per lesson would be returned by default, subject to the number of questions 146 per lesson 122 available in the sentence repository 140. The desired distribution of questions 146 per lesson in the list may be specified via the number of questions parameter, parameter which may include a list of numbers.

Grammar Test Repository

In accordance with the implementation of the embodiment of the invention presented herein, the grammar teaching system 100 may further include a grammar test repository 170 configured to retrievably store a multitude of grammar tests 162. The grammar test repository 170 may further be configured to store at least one list 172 of grammar tests (162).

In accordance with the implementation of the embodiment of the invention presented herein, the test generator 160 may further employ the randomizer 166 configured to perform one of randomly selecting a question 146 from a multitude of questions 146 (for example a multitude of questions returned by the sentence repository 140 in response to a query), or randomize a grammar test 162 (for example a grammar test 162 stored in the test storage 170). Randomizing a grammar test 162 may be desirable in administering the same grammar test 162 to multiple students in close quarters.

The Test Feedback Generator

In accordance with the implementation of the embodiment of the invention presented herein, the feedback generator 180 is configured to receive a completed grammar test 182 (typically a previously produced grammar test 162) and to provide feedback thereon. For example, aside from student identification, the difference between a produced grammar test 162 and the corresponding completed test 182 received may be the presence of received answers.

The feedback generator 180 includes a comparator 184 configured to compare a received answer with the expected answer 147 for each question 146 in the received grammar test 182. For example, the expected answer 147 and the received answer are specific words.

In accordance with the implementation of the embodiment of the invention presented herein, yet without limiting the invention, a completed grammar test 182 includes an associative data structure, referred to herein as a tuple, specifying an association between a received answer and a question 146 in the received grammar test 182. Another tuple associated with the question 146 may be employed to specify the association between the corresponding sentence 142 and the corresponding grammar lesson 122. The feedback generator 180 is further configured to query the sentence repository 140 to obtain the expected answer 147 based on the associative information retrieved from the received grammar test 182.

In accordance with the embodiment of the invention, the feedback generator 180 includes a tabulator 188 configured to tabulate, for each question 146 in the received grammar test 182, the question 146, the sentence 142, the received answer, the expected answer 147, and a received answer correctness indication determined by the comparator 184.

In accordance with the embodiment of the invention, the tabulator is further configured to include a lesson identifier (126) referencing a grammar lesson 122 for which an incorrect answer was received.

The feedback generator 180, may further include a sorter 185 configured to sort questions 146 in the completed received test 182 according to grammar lesson 122 associations thereof An aggregator 186 may be employed to track the number of correct answers per lesson. Without limiting the invention, the aggregator 186 may count, bin, compute differentials between, etc. per lesson received answers. The comparator 184 may be further configured to compare the number of correct answers per lesson against a proficiency expectation 187. Without limiting the invention, grammar proficiency expectations 187 may be provided non-descript, on a per lesson basis, etc. Without limiting the invention, a class (school, school board, previous year's grammar aptitude test median score, etc.) average may represent a grammar proficiency expectation 187.

Exercise Generator

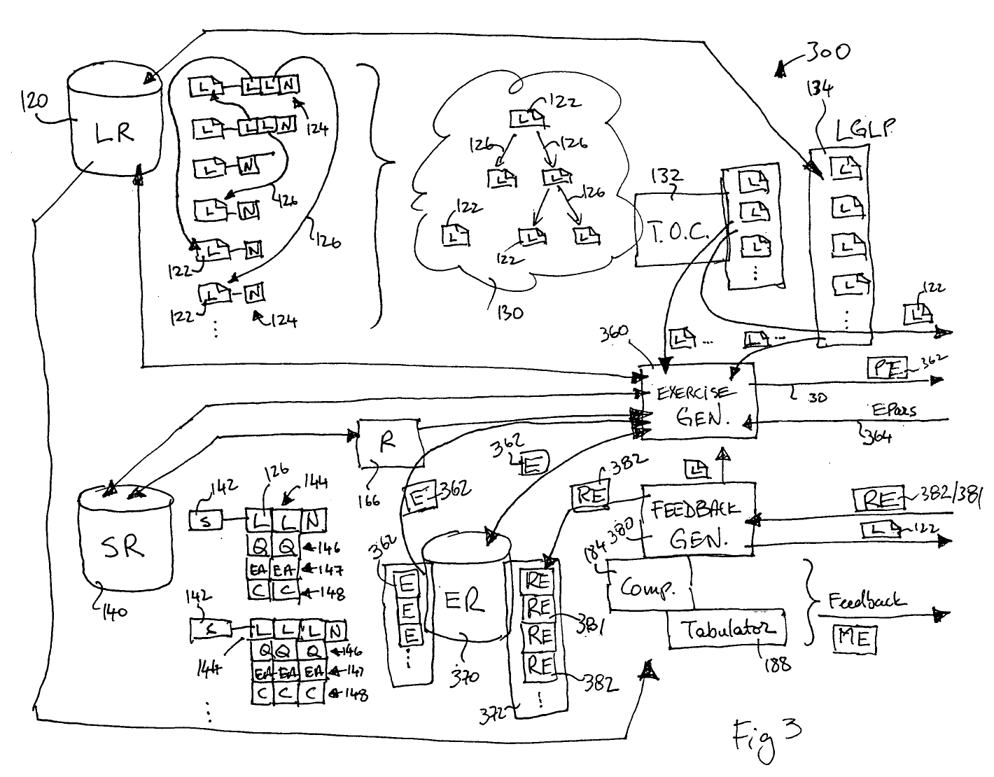

In accordance with another implementation of embodiment of the invention, the grammar teaching system 100 may include a grammar exercise generator 360 as shown in FIG. 3. The grammar exercise generator 360 is configured to produce 330 a grammar exercise 362 according to grammar exercise parameters 364. A grammar exercise 362 includes a list of questions 146, each question 146 having a corresponding sentence 142 to which the question 146 relates.

The grammar exercise generator 360 is configured to obtain, from the sentence repository 140, at least one question 146/sentence 142 pair for inclusion in a grammar exercise 362. The grammar exercise generator 360 is configured to formulate at least one query for the sentence repository 140 based on the exercise parameters 364. As described herein above, a query submitted to the sentence repository 140 may return a multitude of questions 146. Obtaining a question 146 typically includes obtaining a corresponding sentence 142. It is envisioned that sentences 142 may be obtained from the sentence repository 140 on demand, for example by querying the sentence repository 140 with a specific question 146 via the association between the question 146 and the sentence 142.

Without limiting the invention, the grammar exercise parameters 364 may include: a list of grammar lessons, a number of questions, and optionally a desired mix of grammatical correctness of sentences to be compiled in the grammar exercise 362.

Without limiting the invention, as will be described herein below, an aptitude improvement exercise may be requested by specifying the table of contents 330 as the list of grammar lessons, a lesson specific retention improvement exercise may be requested by specifying (a list of grammar lessons containing) a specific grammar lesson 122, a grammar concept specific exercise may be requested by providing a list of selected grammar lessons 122 associated with the grammar concept, and a grammar retention improvement exercise may be requested by specifying the list of grammar lessons produced 134 as the list of grammar lessons.

Similarly as mentioned above by way of example in respect of test generation, the desired mix of grammatical correctness grammar exercise parameter may specify, when present, that only grammatically correct sentences be included in the grammar exercise 362, that only grammatically incorrect sentences be included in the grammar exercise 362, or that the grammar exercise 362 include sentences having mixed grammatical correctness. Depending on implementation, if the desired mix of grammatical correctness parameter is not specified, by default the generated exercise 362 may include only grammatically correct sentences or a 50/50 mix thereof, subject to sufficient numbers of grammatically correct and grammatically incorrect sentences 142 being available in the sentence repository 140 for the specified list of lessons.

Similarly, when the list of lessons includes more than one lesson 122, without limiting the invention, an equal number of questions 146 per lesson would be included by default, subject to the number of questions 146 per lesson 122 available in the sentence repository 140. The desired distribution of questions 146 per lesson in the list may be specified via the number of questions parameter, parameter which may include a list of numbers.

In accordance with the second implementation of the embodiment of the invention presented herein, a reference 126 to the grammar lesson 122 corresponding to each question 146 is included in the produced grammar exercise 362. The reference 126 to the grammar lesson 122 corresponding to each question 146 may be displayed concurrently with the question 146. Without limiting the invention, the reference 126 to the grammar lesson 122 may be provided for display below the question 146. Providing the reference 126 enables the recall of a grammar lesson 122 corresponding to the question 146 during the exercise.

Grammar Exercise Repository

In accordance with the implementation of the embodiment of the invention presented herein, the grammar teaching system 100 may further include a grammar exercise repository 370 configured to retrievably store a multitude of grammar exercises 362. The grammar exercise repository 370 may further be configured to store at least one list 372 of grammar exercises (362).

In accordance with the second implementation of the embodiment of the invention presented herein, the exercise generator 360 may further employ the randomizer 166 to perform one of randomly selecting a question 146 from a multitude of questions 146 (for example a multitude of questions returned by the sentence repository 140 in response to a query), or randomize a grammar exercise 362 (for example a grammar exercise 362 stored in the exercise storage 370). Randomizing a grammar exercise 362 may be desirable in administering the same grammar exercise 362 to multiple students in close quarters.

Exercise Feedback Generator

In accordance with the alternate implementation of the embodiment of the invention presented herein, a feedback generator 380 is configured to receive one of: an incomplete grammar exercise 381 (typically a previously produced grammar exercise 362) with a request for a review of a grammar lesson 122, and receive a completed grammar exercise 382 for which feedback is to be provided. In respect of a completed grammar exercise 382, aside from student identification, the difference between a produced grammar exercise 362 and the corresponding completed exercise 382 received may be the presence of received answers.

An incomplete grammar exercise 381 is received, for example, due to the student interacting with a reference 126 to a grammar lesson 122 corresponding to a question 146. The feedback generator 380 uses the reference 126 to query the lesson repository 120 to cause the production 456 of the grammar lesson 122. The feedback generator 380 is further configured to cause the storage of the incomplete grammar exercise 381 in the grammar exercise repository 370.

In accordance with the second implementation of the embodiment of the invention, in producing a grammar lesson 122, the grammar teaching system 300 is further configured to include a link or a reference to the incomplete grammar exercise 381 stored in the grammar exercise repository 370. The grammar teaching system 300 is further configured to receive a request for proceeding with the incomplete grammar exercise 381, the request including a reference to the incomplete grammar exercise 381 stored in the grammar exercise repository 370. In response to such a request for proceeding with the incomplete grammar exercise 380, the grammar teaching system 300 is configured to cause the production of the incomplete grammar exercise 381 from the grammar exercise repository 370.

Once a completed grammar exercise 382 is received, the feedback generator 380 is configured to process a completed grammar exercise 382 much like a completed grammar test 182. For this purpose, the feedback generator 380 employs comparator 184 to compare a received answer with the expected answer 147 for each question 146 in the received grammar exercise 382. For example, the expected answer 147 and the received answer are specific words.

In accordance with the second implementation of the embodiment of the invention presented herein, yet without limiting the invention, a completed grammar exercise 382 includes an associative data structure, referred to herein as a tuple, specifying an association between a received answer and a question 146 in the received grammar exercise 382. Another tuple associated with the question 146 may be employed to specify the association between the corresponding sentence 142 and the corresponding grammar lesson 122. The feedback generator 380 is further configured to query the sentence repository 140 to obtain the expected answer 147 based on the associative information retrieved from the received grammar exercise 382.

In accordance with the embodiment of the invention, the feedback generator 380 includes the tabulator 188 to tabulate, for each question 146 in the received grammar exercise 382, the question 146, the sentence 142, the received answer, the expected answer 147, and a received answer correctness indication determined by the comparator 184.

In accordance with the embodiment of the invention, the tabulator 188 is further configured to include a lesson identifier (126) referencing a grammar lesson 122 for which an incorrect answer was received.

Without limiting the invention, the grammar teaching system 100 may be implemented on a server connected to a communications network, the server having associated therewith the repositories and components described herein above, wherein a student accesses the server remotely from a host computer or console. Other implementations may include a student associated computer or console having associated therewith the repositories and components described herein above.

Representative Functionality

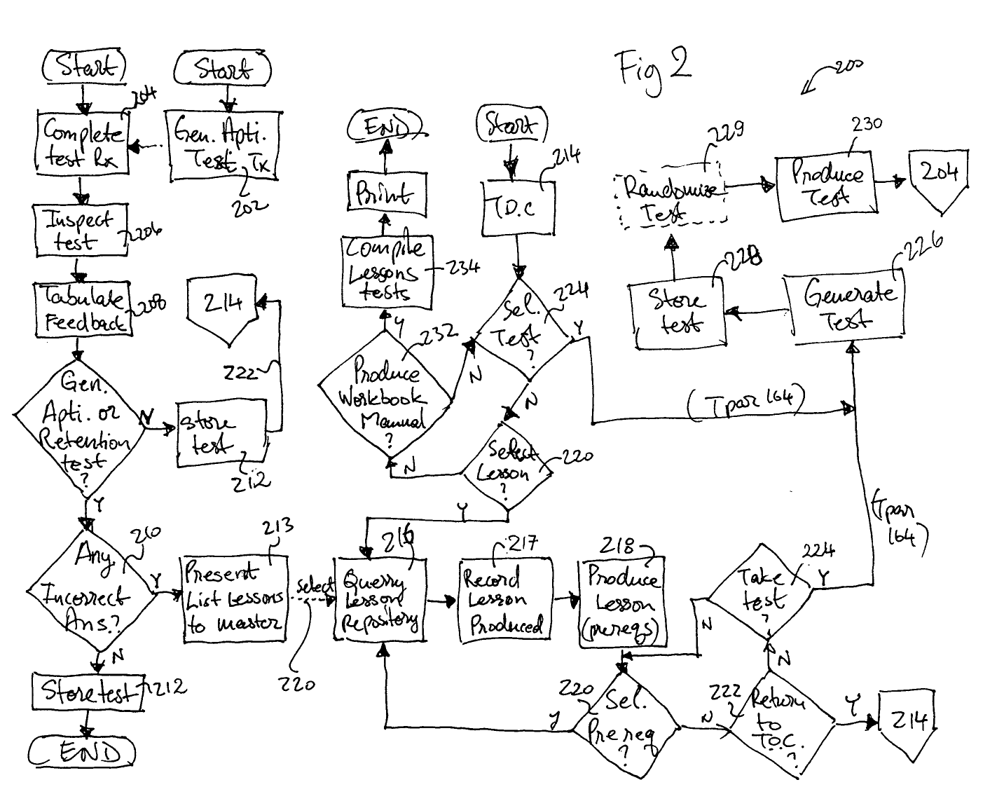

The grammar teaching system 100 described above lends itself to be employed in a variety of grammar teaching environments. FIG. 2 is a flow diagram showing generalized process steps implementing a method of teaching grammar in accordance with the embodiment of the invention. The process presented in FIG. 2 is shown to have multiple entry steps representing different uses (options).

For example, a student may initially be presented with a grammar aptitude test 202. The student completes the test 204. The completed test submitted to the grammar teaching system 100 is inspected 206 by the feedback generator 180, and feedback is tabulated 208.

If all received answers are found 210 to be correct, the process may store 212 the received test in the test repository 170 and terminates.

If at least one question 146 was answered incorrectly, the student is presented 213 with a reference (126) to a grammar lesson 122 for which not all questions 146 were answered correctly. Without limiting the invention, the references (126) to grammar lessons 122 may be presented in an (ordered) list or tabulated in respect to each incorrectly answered question.

In accordance with another example of use, a student may be presented 214 with the table of contents 134 as a starting point.

The selection 220 of any grammar lesson 122 by the student is recorded 217 as a presented lesson in the list of grammar lessons produced 134. The grammar lesson repository 120 is queried 216 and the selected grammar lesson 122 is produced 218 for display to the student for the student's perusal.

In accordance with the embodiment of the invention, a displayed grammar lesson 122 includes a displayed representation of the list prerequisite grammar lessons 124 associated therewith. The list of perquisites is obtained 216 from the lesson repository 120 either with the lesson 122 or separately depending on the implementation of the grammar teaching system 100. If the student selects 220 a prerequisite grammar lesson 122, the process resumes from step 216.

Having perused a grammar lesson 122 the student may return 222 to the table of contents 132.

Without limiting the invention, the displayed grammar lesson 122 or the displayed table of contents 132 may include an option to proceed 224 with a grammar test 162. Depending on various factors, including but not limited to which grammar lessons 122 are stored in the list of grammar lessons produced 134, a selection of grammar tests 162 may be provided to the student either accessible directly via a currently displayed grammar lesson 122 or via (224) the table of contents 132 such as: a grammar lesson specific retention test, a grammar concept specific test, and a grammar retention test.

Based on the functionality of the system of teaching grammar 100 presented herein above, proceeding 224 with a grammar test 162 may include, however is not limited to: generating 226 a grammar test 162 in accordance with test parameters 164 applicable to the selected grammar test type and the teaching context. The grammar test repository 170 may contain standard grammar tests 162. A generated test may be stored 228 in the grammar test repository 170. A grammar test 162 in the grammar test repository 170 may be randomized 229.

The selection to proceed 226 with a grammar test culminates with a grammar test 162 being produced 230 for display to, and completion by, the student. Once the grammar test 162 is completed and submitted to the grammar teaching system 100, the process 200 resumes from step 204.

The grammar teaching system 100 may track grammar lessons 122 in respect of which student performance is below proficiency expectation(s) and provide the student with further opportunities to review a grammar lesson 122 and to take a (further) grammar test 162. Taking a further test may include the formulation of a request for the generation of a new grammar test 162 by the test generator 160. Without limiting the invention, the feedback generator 180 may generate the request which is produced for inclusion by the tabulator 188 in the feedback provided to the student as described hereinabove.

In accordance with the embodiment of the invention, the student is provided with the option 232 to obtain a manual and workbook, the grammar teaching system 100 being further configured to produce 234, without limiting the invention thereto, one of:
the table of contents 132, all grammar lessons 122 in the grammar lesson repository 120, and any standard grammar tests 162 stored in the grammar test repository 170;
the list of grammar lessons produced 134, all grammar lessons produced 122, all completed grammar tests 162, and all completed grammar exercises 362;
the table of contents 132 with an indication of which grammar lessons 122 were produced, all grammar lessons 122 in the grammar lesson repository 120 with an indication of the level proficiency attained, all grammar tests 162 in the grammar test repository 170 which were not taken, and every grammar test 182 received with an indication of the level of proficiency attained, and every grammar exercise received 382 with an indication of student's performance;
etc.

Exercise Functionality

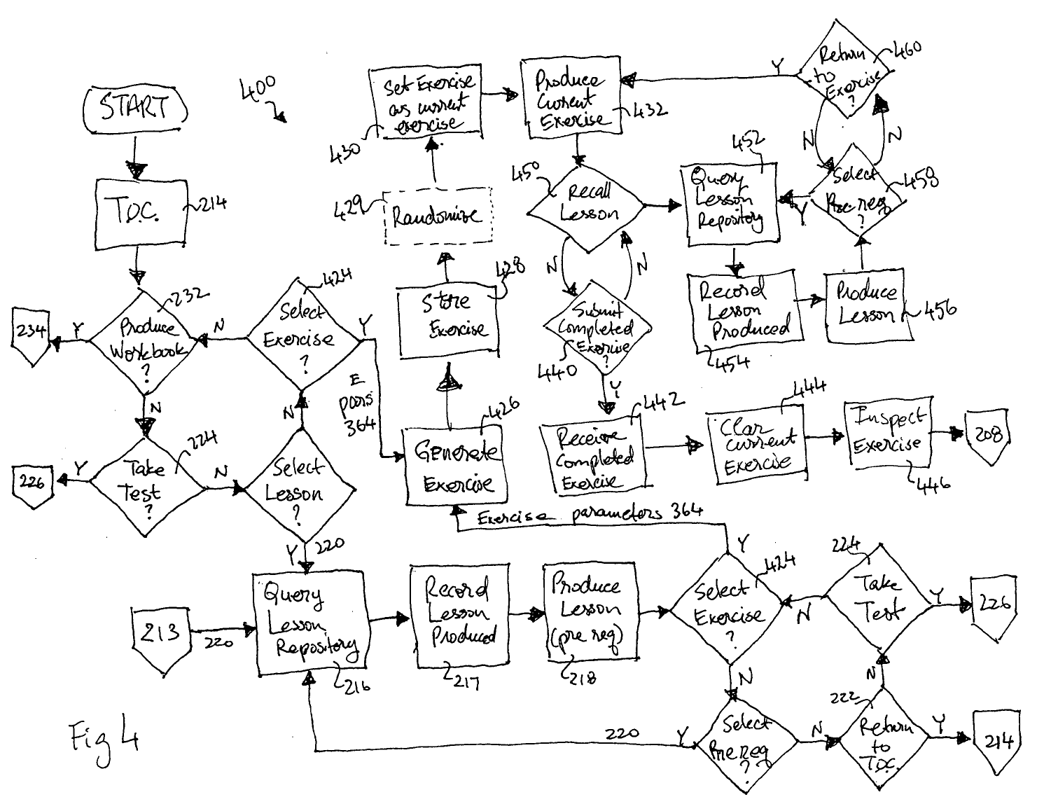

A modified process 400 is shown in FIG. 4 to include functionality employed in administering an exercise in accordance with the second implementation of the embodiment of the invention presented herein.

From the table of contents 132 displayed in step 214, the student may opt to proceed 424 with an exercise in respect of a grammar lesson 122. Alternatively, while reviewing a grammar lesson 122 produced in step 218, the student may opt to proceed 424 with an exercise. In accordance with the second implementation of the embodiment of the invention, proceeding with an exercise may include providing exercise parameters 364 to the exercise generator 360 or cause the selection of a previously prepared exercise.

The exercise generator 360 generates 426 an exercise 362 in accordance with the exercise parameters 364 provided thereto. The generated exercise 362 may be stored 428 in the exercise repository 370. The generated exercise 362 may be randomized 429 by randomizer 166 before being produced 432. Without limiting the invention, producing 432 the exercise 462 includes identifying the exercise 362 as the current exercise.

The student reviews the exercise 362 with the intention to complete answers to questions 146. Preferably, the exercise 362 is presented to the student in the absence of the relevant grammar lesson(s) 122.

If the student feels comfortable with the subject matter of the exercise 362, the student would complete the exercise 362 and submit 440 the completed exercise 382 to the feedback generator 380. The feedback generator 380 receives 442 the completed exercise 382, clears 444 the current exercise specifier, inspects 446 the received exercise 382, and the process returns from step 208.

In accordance with the exemplary embodiment of the invention, if the student feels challenged by a question 146 in the exercise 362, the student may recall 450 the grammar lesson 122 corresponding to the question 146. The grammar teaching system 300 obtains the grammar lesson 122 from the lesson repository 120, for example via a query 452. The recalled grammar lesson 122 is recorded 454 as having been produced 456.

While reviewing the grammar lesson 122 produced, the student may select 458 a prerequisite grammar lesson 122 and the process 400 returns to step 452.

Having gained familiarity with the subject matter of the question 146, the student may select 460 to return to the exercise 362 and the process 400 resumes from step 432.

Without limiting the invention, the functionality of the grammar teaching system 100/300 may be implemented as coded logic including the grammar teaching processes 200/400. A computer-readable medium may include computer-executable instructions for performing the functionality of the grammar teaching system 100/300 and/or coded logic implementing grammar teaching process 200/400.

The term computer-readable medium is understood to include, without being limited thereto: any kind of computer memory such as, punch cards, ticker tape, magnetic tape, floppy disks, conventional hard disks, CD-ROMs, writable CDs, re-writable CDs, DVDs, writable DVDs, re-writable DVDs, Flash ROMs, writable Flash, re-writable Flash, PROM, EPROM, EEPROM, nonvolatile ROM, magneto-optical disk, RAM, optical storage system, fiber loop storage system, holographic data storage system, and MEMS-based scanning-probe data-storage system.

Although various aspects of the present invention have been described herein including for example a lesson repository, a lesson hierarchy, a sentence repository, a list of lessons, a list of lessons relevant to a sentence, a randomizer, a test generator, a test repository, a list of tests, an exercise generator, an exercise repository, a list of exercises, a feedback generator, a comparator, an aggregator, a sorter, and a tabulator, it is to be understood that each of these features may be used independently or in various combinations, as desired, in a grammar teaching system 100/300.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or “step for”.

I claim:

1. An interactive system for teaching grammar, the system comprising:
a. a grammar lesson repository configured to retrievably store a plurality of grammar lessons, each grammar lesson having a list of prerequisite lessons associated therewith, the plurality of prerequisite list entries defining a lesson hierarchy;
b. a sentence repository configured to retrievably store a plurality of sentences, each sentence having a list of grammar lesson associations, each lesson association specifying a question and an expected answer;
c. one of:
i. an exercise generator configured to produce a grammar exercise according to grammar exercise parameters, and
ii. a test generator configured to produce a grammar test according to grammar test parameters; and
d. a feedback generator configured to receive at least one of a completed grammar test and a completed grammar exercise, and provide feedback thereon.

2. A system as claimed in claim 1, wherein each grammar lesson further comprises one of:
a. a stand-alone lesson having an empty list of prerequisite lessons,
b. a prerequisite lesson being referenced in at least one list of prerequisite lessons, and
c. a lesson having at least one prerequisite.

3. A system as claimed in claim 1, wherein each sentence is one of a grammatically correct and a grammatically incorrect sentence, the sentence repository being configured to store an indication of grammatical correctness for each question.

4. A system as claimed in claim 3, wherein the parameters further include at least one of a number of questions to be tested, and a desired mix of grammatical correctness of sentences to be compiled in the grammar test.

5. A system as claimed in claim 1, wherein the grammar lesson repository is further configured to produce a grammar lesson on request, the system further comprising:
a. a table of contents suggesting a sequence of presentation of the plurality of grammar lessons based on the lesson hierarchy; and
b. at least one list of grammar lessons produced, each list of grammar lessons produced being configured to store at least one grammar lesson identifier ordered according to a sequence in which the grammar lessons were produced.

6. A system as claimed in claim 5, wherein the test generator is further configured to produce one of:
a. an aptitude test including a compilation of questions associated with all lessons in the table of contents,
b. a grammar lesson specific retention test including at least one question associated with a single grammar lesson,
c. a grammar concept specific test including at least one question associated with at least one grammar lesson, and
d. a grammar retention test including a group of questions associated with at least one lesson in the list of lessons produced.

7. A system as claimed in claim 5, wherein the exercise generator is further configured to produce one of:
a. an aptitude exercise including a compilation of questions associated with all lessons in the table of contents,
b. a grammar lesson specific retention exercise including at least one question associated with a single grammar lesson,
c. a grammar concept specific exercise including at least one question associated with at least one grammar lesson, and
d. a grammar retention exercise including a group of questions associated with at least one lesson in the list of lessons produced,
each question including a reference to a corresponding grammar lesson.

8. A system as claimed in claim 1, the feedback generator further comprising:
a. a comparator configured to compare a received answer with an expected answer for each question; and
b. a tabulator configured to tabulate for each question: the question, the sentence, the received answer, the expected answer, and a determined received answer correctness indication.

9. A system as claimed in claim 8, the tabulator being further configured to tabulate a lesson identifier corresponding to at least one question for which an incorrect answer was received.

10. A system as claimed in claim 8, the feedback generator further comprising:
a. a sorter configured to sort questions in the completed test according to lesson associations thereof;
b. an aggregator configured to track correct answers per lesson; and
c. the comparator being further configured to compare the number of correct answers per lesson against a proficiency expectation.

11. A system as claimed in claim 1, further comprising a corresponding one of:
a. a grammar test repository configured to retrievably store at least one grammar test, and
b. a grammar exercise repository configured to retrievably store at lest one grammar exercise.

12. A method of administering a grammar test, the method comprising:
a. receiving a completed grammar test including at least one tuple specifying an association between an answer received and a corresponding question;
b. for each question in the completed test, the question including a tuple specifying an association between a sentence and a corresponding grammar lesson,
i. querying a sentence repository based on the sentence and the question, the sentence repository being configured to retrievably store a plurality of sentences, each sentence having a list of grammar lesson associations, each lesson association specifying a question and an expected answer;
ii. obtaining the expected answer to the question;
iii. determining an indication of correctness of the provided answer; and
iv. tabulating the question, the sentence, the provided answer, the expected answer, and the indication of correctness.

13. A method as claimed in claim 12, further comprising prior steps of:
a. generating a grammar test based on grammar test parameters; and
b. producing the grammar test.

14. A method as claimed in claim 13, further comprising receiving a request for generating a test, the request including at lest one of a grammar test type, a number of questions, and a desired mix of grammatical correctness of sentences to be compiled in the grammar test.

15. A method as claimed in claim 12, further comprising:
a. determining a level of grammar proficiency; and
b. producing at least one lesson identifier corresponding to at least one question for which an incorrect answer was received.

16. A method as claimed in claim 15, further comprising:
a. formulating the request for generating the grammar test; and
b. producing the request.

17. A method as claimed in claim 15, wherein determining the level of grammar proficiency further comprising:
a. sorting questions in the completed test according to lesson associations;
b. counting the number of correct answers per lesson; and
c. producing tabulation of lesson specific proficiencies.

18. A method as claimed in claim 17, wherein the grammar test is one of an aptitude test, a grammar concept specific test, and a grammar retention test, the grammar test including more than two questions per grammar lesson, the method further comprising:
a. ranking grammar proficiency in respect of each lesson; and
b. comparing the number of correct answers per lesson with a lesson specific proficiency expectation; and
c. producing at least one lesson identifier corresponding to at least one lesson for which the number of correct answers received is below the lesson specific proficiency expectation.

19. A method as claimed in claim 12, further comprising:
a. storing the completed grammar test received in a grammar test list; and
b. producing a grammar manual and workbook including one of all lessons in the table of contents and the lessons in the list of lessons produced, and the grammar tests received in the grammar test list.

20. A method of administering a grammar exercise comprising the steps of:
a. producing a grammar exercise without grammar lesson content, each question in the grammar exercise having a reference to a corresponding lesson;
b. receiving an incomplete grammar exercise with a request to recall a grammar lesson;
c. storing the incomplete grammar exercise;
d. producing the requested grammar lesson;
e. receiving a request to proceed with the grammar exercise;
f. producing the incomplete grammar exercise without grammar lesson content;
g. receiving a completed grammar exercise; and
h. providing feedback on the completed grammar exercise.

21. A method as claimed in claim 20, wherein receiving the incomplete grammar exercise the method further comprises setting the received incomplete exercise as a current exercise and wherein producing the incomplete grammar exercise the method further comprises producing the current exercise.

22. A method as claimed in claim 20, wherein producing the grammar lesson the method further comprises obtaining the grammar lesson from a lesson repository.

23. A method as claimed in claim 20 further comprising storing each received grammar exercise in a grammar exercise list, the method further comprises producing a grammar manual and workbook including one of lessons in a table of contents and lessons in a list of lessons produced, and the grammar exercises received in the grammar exercise list.

24. A computer-readable medium comprising computer-executable instructions for performing one of the methods claimed in claims 12 and 20.
